(19) United States
(12) Patent Application Publication
(10) Pub. No.: US 2006/0050927 A1
(43) Pub. Date: Mar. 9, 2006

(54) Camera arrangement

(76) Inventors: Marcus Klomark, Wikingstad (SE); Mattias Hanqvist, Linkoping (SE); Karl Munsin, Sodertalje (SE); Salah Hadi, Linkoping (SE)

Correspondence Address: BRINKS HOFER GILSON & LIONE, P.O. BOX 10395, CHICAGO, IL, 60610, US

(21) Appl. No.: 10/502,126

(22) PCT Filed: Dec. 19, 2002
(86) PCT No.: PCT/SE02/02382

§ 371 Date: Jun. 9, 2005

(30) Foreign Application Priority Data
Jan. 16, 2002 (GB) 0200954.6
May 29, 2002 (GB) 0212411.3

(51) Int. Cl. G06K 9/00

(52) U.S. Cl. 382/103

(57) ABSTRACT

A camera arrangement is mounted on a motor vehicle to detect a human within or outside the vehicle. The output from the camera is processed by a processor to identify any area or areas of the captured image which have a specific spectral content representative of human skin. A processor may determine the position of any identified area within the image and may control or modify the actuation of one or more safety devices. The arrangement may be used in a motor vehicle, and the processor may control or modify the deployment of a safety device, such as an air-bag, depending upon the position of a seat occupant or a safety device for a pedestrain.

THE PRESENT INVENTION relates to a camera arrangement and more particularly relates to a camera arrangement for use with a safety device, in particular in a motor vehicle.

In connection with the deployment of a safety device in a motor vehicle it is sometimes important to be able to detect and identify objects located in the region above and in front of a vehicle seat. For example, it may be necessary to determine the position of at least part of the occupant of the seat, for example the head of the occupant of the seat, so as to be able to determine the position of the occupant of the seat within the seat. If the occupant is leaning forwardly, for example, it may be desirable to modify the deployment of safety equipment in the vehicle, such as a safety device in the form of an airbag mounted directly in front of the occupant of the seat, if an accident should occur. In the situation envisaged it may be appropriate only to inflate the airbag partially, rather than to inflate the airbag fully.

If the front seat of a vehicle is not occupied by a person, but instead has a rear-facing child seat located on it, then it may be desirable to modify the deployment of an airbag located in front of that seat, in the event that an accident should occur, in such a way that the airbag does not inflate at all. If the airbag did inflate it might eject the child from the rear facing child seat.

Many prior proposals have been made concerning techniques that can be utilised to determine the position of part of an occupant of a seat and also to determine whether a seat is occupied by a rear-facing child seat. Some prior proposals have utilised optical techniques, and others have utilised techniques involving ultrasonic radiation or even “radar”. In many prior arrangements the sensors have been mounted in front of the seat, and the signals derived from the sensors have been processed to calculate the distance between the occupant of the seat, or an item on the seat, and the sensors.

It is now becoming increasingly important to be able to detect the position of a pedestrian in front of a motor vehicle, as more vehicles have safety devices which may be deployed in an accident situation to provide protection for a pedestrian. The mode of deployment of these devices may be controlled in dependence on the number of pedestrians involved in an accident, and the size of the pedestrians. A camera may actuate a safety device to provide protection for pedestrians.

The present invention seeks to provide an improved camera arrangement which can be utilised to detect and evaluate objects on and above a vehicle seat.

According to this invention there is provided a camera arrangement to be mounted in a vehicle to detect a human, the arrangement comprising a camera to capture a light image, the camera providing an output signal; and a processor operable to analyse the signal to identify any area or areas of the captured image which have a specific spectral content representative of human skin, and to determine the position of any so identified area or areas within the image.

Preferably the processor is adapted, in response to the determined position of the area or areas, to control or modify the actuation of one or more safety devices.

Conveniently the processor is adapted to determine successive positions of the identified area or areas to determine a parameter related to the movement of the identified area or areas, the processor being adapted to control or modify the actuation of one or more safety devices in response to the determined parameter.

Advantageously the camera is directed towards a space in front of the vehicle and the safety device is a pedestrian protection device.

Preferably the camera arrangement is adapted to trigger the pedestrian protection device.

Conveniently the camera arrangement is adapted to control deployment of the pedestrian protection device.

In an alternative embodiment the camera is directed towards the space above and in front of a seat within the vehicle compartment.

In one embodiment of the invention the camera is laterally displaced relative to the seat, the viewing axis of the camera extending transversely of the vehicle.

In an alternative embodiment of the invention two cameras are provided, the cameras being located in front of the seat, the processor being adapted to use triangulation to determine the distance from the cameras to an identified area in the image.

Conveniently the processor analyses the signal to identify specific features of a head.

Preferably the processor analyses the signal to identify any area or areas of the captured image which have, in the H,S,V space, H greater than or equal to 335° or less than or equal to 25°, S between 0.2 and 0.6 inclusive, and V greater than or equal to 0.4.

Advantageously the arrangement is adapted to have a first mode of operation when the surrounding brightness is above a first predetermined threshold and a second mode of operation when the surrounding brightness is below a second predetermined threshold.

Conveniently a light source is provided to illuminate the field of view of the camera, a subtractor being provided to an image with the light not operative from an image with the light operative, the resultant image being analysed to determine the position of an identified area or areas within the image, wherein the light source emits light outside the visible spectrum, and the camera is responsive to light of a wavelength as emitted by the light source.

Preferably, the arrangement is configured such that the light source and subtractor are operable as defined in the preceding paragraph only if the ambient light in the field of view of the camera is below the second predetermined threshold.

Advantageously, the processor is operable to analyse the signal from the camera to identify any area or areas of the captured image which have a specific spectral content representative of human skin, only when the ambient light in the field of view of the camera is above the first predetermined threshold.

Conveniently, the first and second predetermined thresholds are equal.

Advantageously said light source is an infra-red light source.

In order that the invention may be more readily understood, and so that further features thereof may be appreciated, the invention will now be described, by way of example, with reference to the accompanying drawings in which:

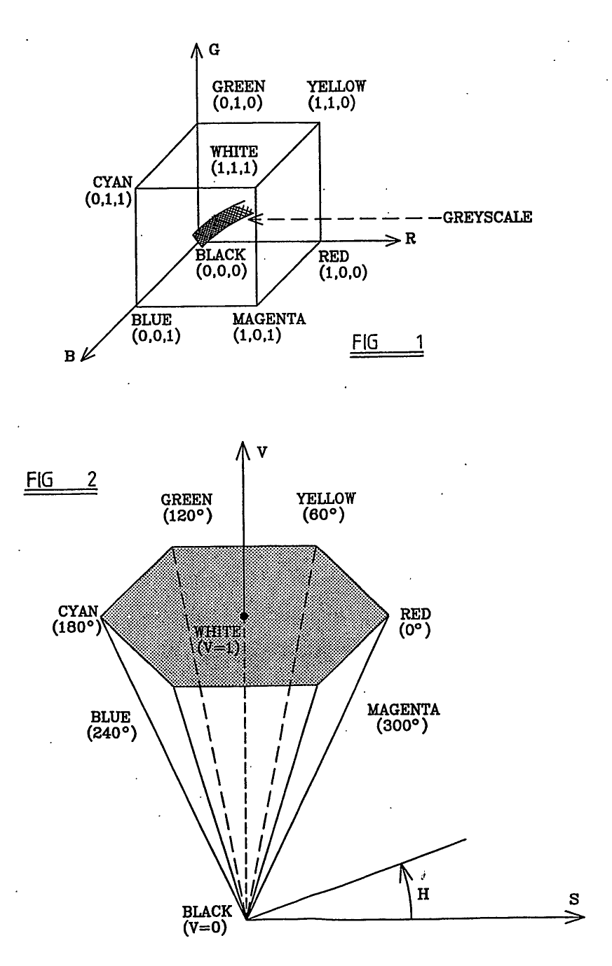

FIG. 1 is a representation of a first colour model provided for purposes of explanation,

FIG. 2 is a corresponding diagram of a second colour model provided for purposes of explanation,

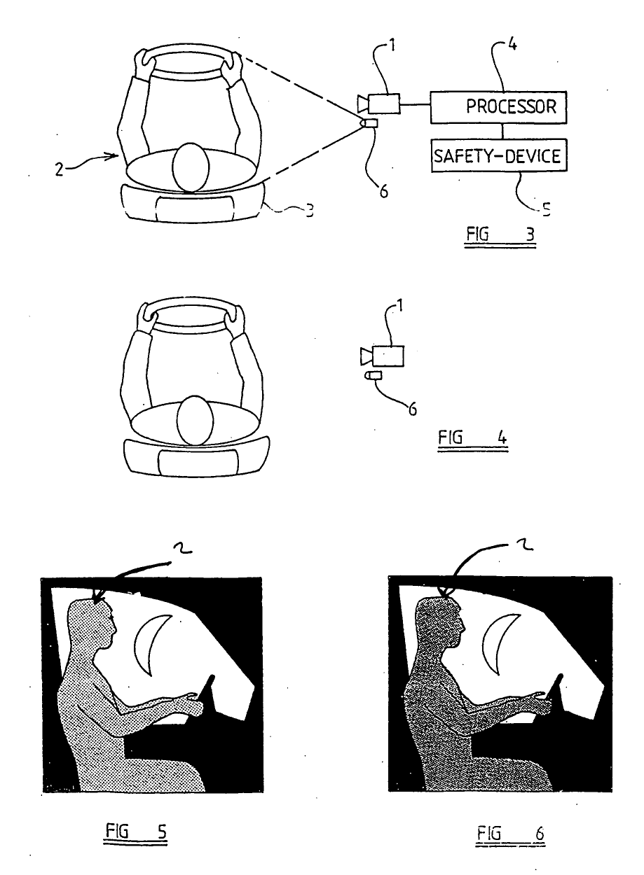

FIG. 3 is a diagrammatic top plan view of part of the cabin of a motor vehicle illustrating a camera arrangement in accordance with the invention illustrating an optional light source that forms part of one embodiment of the camera arrangement in the operative condition,

FIG. 4 is a view corresponding to FIG. 3 illustrating the light source in a non-operative condition,

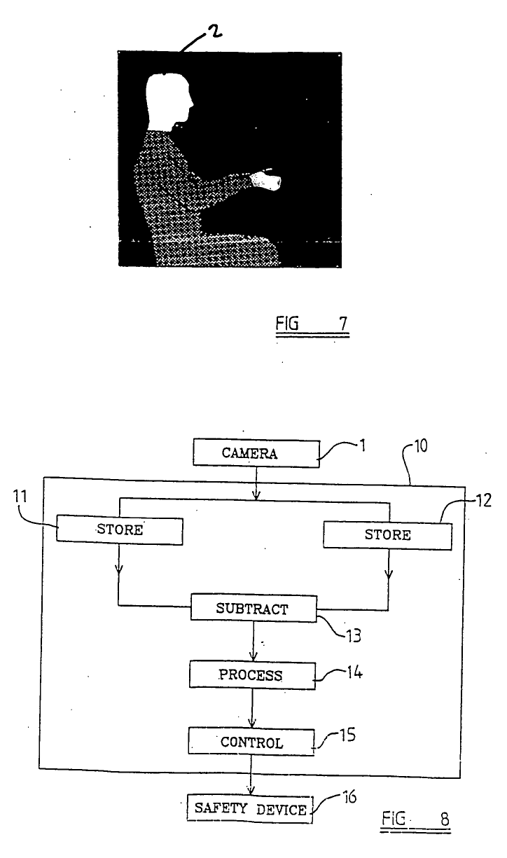

FIG. 5 is a schematic view of the image obtained from the camera arrangement with the light source in an operative condition,

FIG. 6 is a schematic view corresponding to FIG. 4 showing the image obtained when the light source is not operative,

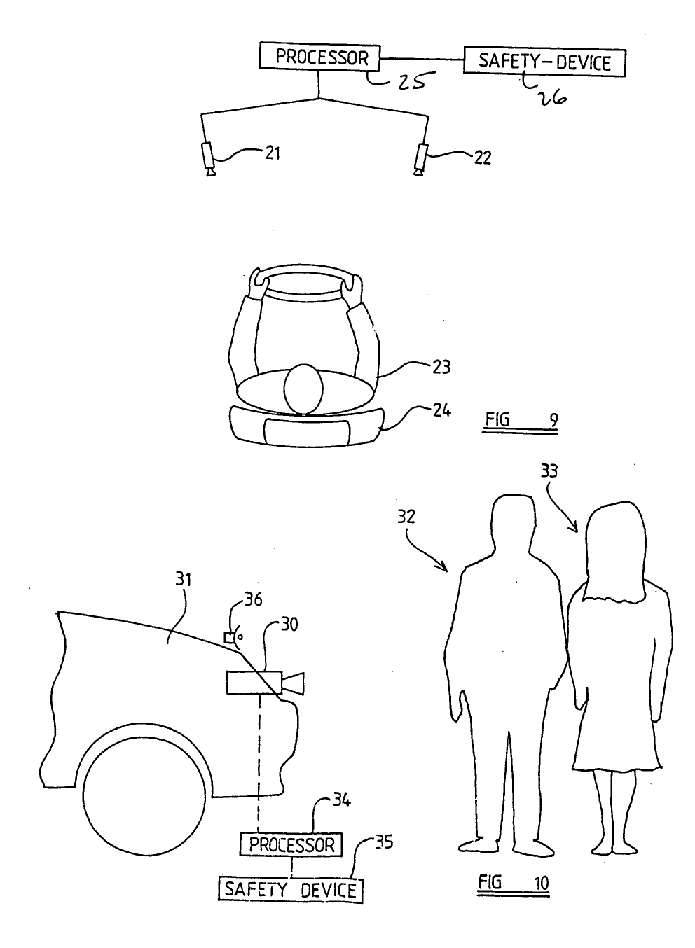

FIG. 7 is a view showing a resultant image obtained by subtracting the image of FIG. 6 from the image of FIG. 5,

FIG. 8 is a block diagram,

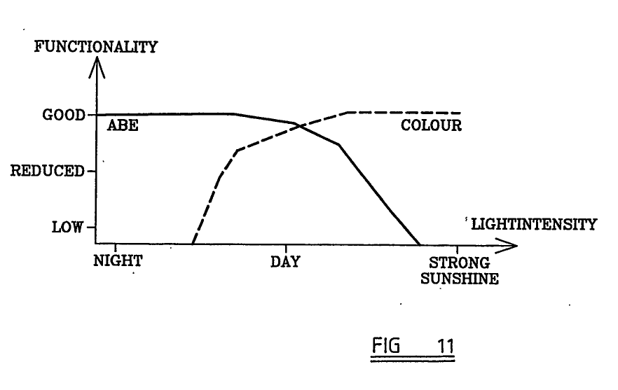

FIG. 9 is a view corresponding to FIG. 3 illustrating a further embodiment of the invention,

FIG. 10 is a diagrammatic side elevational view of the front part of a motor vehicle illustrating an alternative camera arrangement of the present invention configured to detect the position of pedestrians in front of the vehicle, and

FIG. 11 is a graph illustrating the relative effectiveness of two modes of operation of the present invention, with varying light intensity.

There are several colour models which are used to “measure” colour. One colour model is the R,G,B colour model which is most widely used in computer hardware and in cameras. This model represents colour as three independent components, namely red, green and blue. Like the X, Y, Z co-ordinate system, the R,G,B colour model is an additive model, and combinations of R, G and B values generate a specific colour C.

This model is often represented by a three-dimensional box with R, G and B axes as shown in FIG. 1.

The corners of the box, on the axes, correspond to the primary colours. Black is positioned in the origin (0, 0, 0) and white at the opposite corner of the box (1, 1, 1), and is the sum of the primary colours. The other corners which are spaced from the axes represent combinations of two primary colours. For example, adding red and blue gives magenta (1, 0, 1). Shades of grey are positioned along the diagonal from black to white. This model is hard to comprehend for a human observer, because the human way of understanding and describing colour is not based on combinations of red, green and blue.

Another colour model is the H,S,V colour model which is more intuitive to humans. To specify a colour, one colour is chosen and amounts of black and white are added, which gives different shades, tints and tones. The colour parameters here are called Hue, Saturation and Value. In a three-dimensional representation, as shown in FIG. 2, Hue is the colour and is represented as an angle between 0° and 360°. The Saturation varies from 0 to 1 and is representative of the “purity” of the colour—for example a pale colour like pink, is less pure than red. Value varies from 0 at the apex of the cone, which corresponds to black, to 1 at the top, where the colours have their maximum intensity.

Studies have shown that all kinds of human skin, no matter the race of the human being, are gathered in a relatively small cluster in a suitable colour space. It has been found that human skin colours are positioned in a small cluster of the H,S,V space. It has been suggested that appropriate thresholds may be considered to be a Hue between 0° to 25° or between 335° and 360°. Of course, 360° is the same as 0° and thus the range can be considered to be from 335° upwards, through the origin of 0° and continuing on to 25°. A Saturation of 0.2 to 0.6 is appropriate, and a Value of greater than or equal to 0.4 is appropriate.

It is to be appreciated that by using Hue and Saturation, it is possible to obtain an appropriate identification within a large range of lighting intensity.

Most cameras produce R,G,B pixels, and if the H,S,V system has to be used a conversion to H,S,V has to be effected.

Since it has been found that the colour of all kinds of human skin is located within a relatively small and relatively clearly defined volume within the H,S,V space, it is possible to identify a human image on a camera by identifying regions which have a colour within the said defined volume of the H,S,V space.

The present invention therefore uses at least one camera to take a colour image of a part of a motor vehicle where it is anticipated that there may be a human occupant, or an image from a vehicle, the image covering an area in front of the vehicle that may be occupied by a pedestrian, and the image is analysed to identify areas where the colour of the image is within the said defined volume of H,S,V space. Thus the image may be processed to determine if there is a human shown within the image and, if so, the position of the occupant within or relative to the vehicle. This information may be used to control the actuation of one or more active safety devices in the event that an accident should occur.

Referring now to FIG. 3 of the accompanying drawings, a camera arrangement of the present invention includes a camera 1. The camera is responsive to light, and in particular is responsive to light which is within the said defined volume of the H,S,V colour model as representative of human skin.

The camera may be a conventional television camera or a charge-coupled device, or a CMOS camera or any other camera capable of capturing the appropriate image. If the camera is such that the camera produces an output signal in the R,G,B model, that signal is converted to the H,S,V model, or another suitable colour model which might be used for analysis of the image.

The camera 1 is directed towards the region of a motor vehicle expected to be occupied by a human occupant 2 shown sitting, in this embodiment, on a seat 3. The lens of the camera is directed laterally across the vehicle, that is to say the camera is located to one side of the vehicle so as to obtain a side view of the occupant.

The output of the camera is passed to a processor 4 where the image is processed. The image is processed primarily to determine the position of the head of the occupant 2 of the seat 3 within the field of view of the camera. Thus the image taken by the camera is initially analysed by an analyser within the processor to identify any areas of the image which fall within the defined volume of the H,S,V colour model, those areas being identified as being human skin. The area (or areas) thus identified is further processed to identify any large area of human skin that may correspond to the head of the occupant. The image may also be processed to determine the shape and size of any identified area of human skin to isolate details, such as a nose, mouth or eyes, which will confirm that the identified area of the image is an image of a head.

The position of the head within the field of view of the camera is monitored. It would be expected, in the arrangement as shown in FIG. 3, that the head would be towards the left-hand side of the image, if the occupant is in the ordinary position. If the occupant is leaning forwards, the head would be towards the centre, or even to the right-hand side of the field of view. By determining the position of the head of the occupant, the processor is adapted to determine an appropriate mode of operation for a safety device, such as a front-mounted air-bag, and will ensure that the safety device, 5, will, if deployed, be deployed in an appropriate manner, having regard to the position of the person to be protected.

The arrangement as described above, using “colour method” described will operate in a satisfactory manner during daylight hours or when there is a sufficient degree of illumination within the motor vehicle. However, the above-described “colour method” which identifies areas of an image having a spectral content representative of human skin, becomes less effective as the ambient light intensity reduces. This reduction in efficiency of the “colour method” is illustrated in FIG. 11 which is a plot of functionality against light intensity. It is therefore proposed that an alternative mode of operation could be used when the ambient light intensity reduces below a predetermined or calculated effective level.

It is therefore proposed that the camera can be operated in the manner described above (the “colour method”), selecting parts of the image within the defined volume of the H,S,V space, but if the arrangement is unable to identify the position of a seat occupant, for example because of the interior of the vehicle is dark, then the arrangement may enter a second or alternative mode of operation. Alternatively, the arrangement may simply enter the second or alternative mode of operation upon detecting a drop in light intensity below a predetermined value. In order to facilitate the alternative mode of operation, a source of electromagnetic radiation is provided, such as a light source 6, in association with the camera.

The light source 6 generates a diverging beam of light which is directed towards the field of view of the camera 1, with the illumination intensity decreasing with distance from the light source 6.

It is preferred that the light source 6 emits light outside the visible spectrum, such as infra-red light, so as not to distract the driver of the vehicle. The camera 1 is therefore not solely responsive to light within the said defined volume of the H,S,V space, but is also responsive to light of a wavelength as emitted by the light source, for example, infra-red light.

It is envisaged that the sensitivity of the camera 1 and the radiation intensity of the light source 6 will be so adjusted that the camera 1 is responsive to light reflected from the occupant 2 of the seat, but is not responsive (or is not so responsive) to light reflected from the parts of the cabin of the motor vehicle which are remote from the occupant 2, such as the door adjacent the occupant.

It is also envisaged that in the second or alternative mode of operation the camera will, in a first step, capture an image with the light source 6 operational, as indicated in FIG. 3. In a subsequent step the camera will capture an image with the light source non-operational as shown in FIG. 4.

FIG. 5 illustrates schematically the image obtained in the first step, that is to say with the light source operational. Part of the image is the image of the occupant, who is illuminated by the light source 6, and thus this part of the image is relatively bright. The rest of the image includes those parts of the cabin of the vehicle detected by the camera 1, and also part of the image entering the vehicle through the window.

FIG. 6 illustrates the corresponding image taken with the light source 6 non-operational. The occupant 2 of the vehicle is not so bright, in this image, since the occupant is not illuminated by the light source 6, but the rest of the image is virtually the same as the image of FIG. 5.

As shown in FIG. 8, successive signals from the camera 1 are passed to a processor 10 where signals representing the first image, with illumination, are stored in a first store 11, and signals representing the second image, without illuminations, are stored in a second store 12. The two signals are subtracted in the subtractor 13. Thus, effectively the second image, without illumination, is subtracted, pixel-by-pixel, from the first image as shown in FIG. 5, taken with the light source 2 operative. The resultant image, as shown in FIG. 7, consists substantially of an image of only the occupant. The taking of successive images and the subtraction of signals representing the images and the processing step is repeated continuously, in a multiplex manner, to provide a constantly up-dated resultant image. Signals representing the image are passed to a processor 14. It is to be appreciated that in the alternative arrangement as described above, when used with the light 6, will be sequentially operated with the light 6 on and with light 6 off, with a subsequent subtraction of the detected images. Alternative mechanisms, such as a shutter, may be used to interrupt the beam of light.

Referring to FIG. 11, it will be seen that the functionality of the above-described second or alternative method (the “Active Background Elimination (ABE)” method) is greatly improved over that of the first “colour method” in dark conditions. However, as light intensity increases, the ABE method becomes less efficient whilst the colour method becomes more efficient. It is therefore envisaged that during periods of intermediate ambient light intensity, both methods may be employed simultaneously to improve the overall reliability of the arrangement in accurately detecting the presence of a human.

Thus, the ABE method may be used when ambient light intensity is below a first predetermined or calculated level, and the colour method may be used if the ambient light intensity is above a second predetermined or calculated level. The first and second levels may not necessarily be equal. For example, the first light intensity level could be above the second level, in which case there would be a zone of simultaneous ABE and colour operation as described above.

The processor 4 of the embodiment of FIG. 3 or the processor 14 of the embodiment described with reference to FIG. 8 will process the image to determine whether the seat is completely empty or is occupied in any way. The processor is configured to identify and recognise predetermined objects, such as child seats, or parts of objects, such as the head of a human occupant of the seat, or even the nose, mouth or eyes present on the head, and to determine the position thereof relative to the seat. Thus the processor will process the image by determining the nature of the image, for example by determining whether the image is an image of an occupant of a seat or an image of a rear-facing child seat, and will determine the position of part of or the whole of the image.

If the image is an image of a rear-facing child seat the processor may, for example through a control arrangement 15, inhibit deployment of a safety device 5 or 16 in the form of an airbag mounted in the dashboard in front of the seat.

If the processor 14 determines that the image is an image of an occupant the processor will then determine if part of the occupant such as the head of the occupant, is in a predetermined part of the image. Because the field of view of the camera is fixed in position it is possible to determine the position in the vehicle of part of the occupant by determining the position of that part of the occupant within the image. It is thus possible to calculate the distance between part of the occupant, such as the head of the occupant and the dashboard or steering wheel to determine if the occupant is “in position” or “out of position”. If the occupant is “out of position” the deployment of an airbag in front of the occupant may be modified for example by the control arrangement 15. The image processor 4 or 14 may also be adapted to determine the size of the image. Thus the processor 4 or 14 will discriminate between a small seat occupant, such as a child, or a large seat occupant, such an obese adult. The position of the head may be monitored over a period of time, and any movement of the head may be analysed. In dependence upon the result of the processing within the processor, the manner of deployment of an airbag provided to protect the occupant of the seat may be modified, for example, by the control arrangement 15.

FIG. 9 illustrates a modified embodiment of the invention where, instead of having a camera which is located at the side of the vehicle cabin to take a side view of the occupant, two cameras 21, 22 are positioned generally in front of an occupant of a vehicle 23 seated on a seat 24. The cameras are again connected to a processor adapted to identify regions of images taken by the cameras which are within the appropriate volume of the H,S,V space. Using a triangulation technique, the position of the head of the occupant 23 can readily be determined. As in the previously described embodiment, the processor 25 will analyse the image to determine the location of the head of the occupant, possibly determining the location of features such as the nose, mouth or eyes. The processor may determine parameters relating to movement of the head. The processor 25 controls or modifies the actuation of safety device 26, such as front-mounted air-bag or “smart seat belt”, in dependence upon an output from the processor.

Referring now to FIG. 10 of the accompanying drawings, a further camera arrangement in accordance with the invention is illustrated. In this embodiment, the camera arrangement includes a camera 30 which is mounted on the front part of a vehicle 31, so as to view an image of the road in front of the vehicle. It is intended that the camera will receive an image of the road in front of the vehicle and in particular, will receive an image of any pedestrians, such as pedestrians 32, 33 located in front of the vehicle.

The camera, as in the previously described embodiments, passes a signal to a processor 34, which again incorporates an analyser analysing the image to identify the area or areas having the specific colour representative of human skin. The processor is adapted to identify any area or areas having the colour of human skin, and to determine if those areas represent one or more pedestrians located in front of the vehicle. The processor is adapted to actuate or deploy a safety device 35 if pedestrians are identified in front of the vehicle, (in dependence on the speed of the vehicle relative to the pedestrians and the distance between the vehicle and the pedestrians), and the processor may determine a number of pedestrians and the physical size of the pedestrians and control the way in which the safety device 35 is deployed. The safety device 35 may take many forms, and may comprise an external air-bag or may comprise a device adapted to raise part of the bonnet or hood of the motor vehicle.

In this embodiment, a light source 36 may be provided. The light source preferably emits light which is not in the visible spectrum, such as infra-red light. The light source 36 is mounted on the vehicle, and is adapted to operate in the same way as the light source 6 of the embodiment of FIGS. 3 and 4. Thus, in the embodiment, the arrangement may have a second mode of operation in which the light source 36 is alternately turned on and off.

In the present Specification “comprise” means “includes or consists of” and “comprising” means “including or consisting of”.

1. A camera arrangement to be mounted to a vehicle to detect a human, the arrangement comprising, a camera to capture a light image, the camera providing an output signal and a processor, wherein the arrangement is adapted to have a first mode of operation when surrounding brightness of the vehicle is above a first predetermined threshold and a second mode of operation when the surrounding brightness of the vehicle is below a second predetermined threshold; the processor being operable in the first mode of operation only when ambient light in the field of view of the camera is above the first predetermined threshold, to analyse the output signal to identify any area or areas of the light image which have a specific spectral content representative of human skin, and to determine the position of any so identified area or areas within the light image.

2. An arrangement according to claim 1 wherein the processor is adapted, in response to the determined position of the area or areas, to control or modify the actuation of one or more safety devices.

3. An arrangement according to claim 1 wherein the processor is adapted to determine successive positions of the human in the identified area or areas to determine a parameter related to the movement of the human in the identified area or areas, the processor being adapted to control or modify the actuation of one or more safety devices in response to the determined parameter.

4. An arrangement according to claim 2 wherein the camera is directed towards a space in front of the vehicle and the safety device is a pedestrian protection device.

5. An arrangement according to claim 4 wherein the camera arrangement is adapted to trigger the pedestrian protection device.

6. An arrangement according to claim 4 wherein the camera arrangement is adapted to control deployment of the pedestrian protection device.

7. An arrangement according to claim 2 wherein the camera is directed towards the space above and in front of a seat within a compartment of the vehicle.

8. An arrangement according to claim 7 wherein the camera is laterally displaced relative to the seat, the viewing axis of the camera extending transversely of the vehicle.

9. An arrangement according to claim 7 wherein two cameras are provided, the cameras being located in front of the seat, the processor being adapted to use triangulation to determine the distance from the cameras to an identified area in the light image.

10. An arrangement according to claim 1 wherein the processor analyses the signal to identify specific features of a head of the human.

11. An arrangement according to claim 1 wherein the processor analyses the output signal to identify any area or areas of the captured image which have, in a H,S,V space, an H value greater than or equal to 335° or less than or equal to 25°, S between 0.2 and 0.6 inclusive, and V greater than or equal to 0.4.

12. An arrangement according to claim 1 wherein a light source is provided to illuminate the field of view of the camera, a subtractor being provided, the subtractor being operable to subtract an image with the light source not operative from an image with the light source operative, the resultant image being analysed to determine the position of an identified area or areas within the resultant image, wherein the light source emits light outside the visible spectrum, and the camera is responsive to light as emitted by the light source.

13. An arrangement according to claim 12, configured such that the light source and subtractor are operable only if the ambient light in the field of view of the camera is below the second predetermined threshold.

14. An arrangement according to claim 13, wherein the first and second predetermined thresholds are equal.

15. An arrangement according to claim 12 wherein the light source is an infra-red light source.
